(19) United States
(12) Patent Application Publication
(10) Pub. No.: US 2006/0283508 A1
(43) Pub. Date: Dec. 21, 2006

(54) Storage tank filling device

(75) Inventor: Colin T. Scholze, Rimbey (CA)

Correspondence Address: RODMAN RODMAN, 7 SOUTH BROADWAY, WHITE PLAINS, NY, 10601, US

(73) Assignee: 1102167 Alberta Ltd., Rimbey (CA)

(21) Appl. No.: 11/156,021

(22) Filed: Jun. 17, 2005

(51) Int. Cl. F16K 24/00

(52) U.S. Cl. 137/588

(57) ABSTRACT

A filling device for a storage tank which includes a manifold adapted to connect with a tank inlet on the storage tank, and a storage tank system which includes the storage tank and the filling device. The manifold includes an outer conduit communicating with an interior of the storage tank, an inner conduit communicating with the interior of the storage tank and extending within the outer conduit, a gas outlet communicating with one of the outer conduit and the inner conduit, and a liquid inlet communicating with the other of the outer conduit and the inner conduit. The filling device enables the storage tank to be filled with a liquid through the liquid inlet while simultaneously permitting venting of the storage tank through the gas outlet.

### TECHNICAL FIELD

A filling device for a storage tank and a storage tank system comprising a storage tank and a filling device.

### BACKGROUND OF THE INVENTION

A storage tank for a liquid, including a fuel such as gasoline and diesel, typically includes a tank inlet to facilitate filling of the storage tank with the liquid and a tank outlet to facilitate dispensing of the liquid from the storage tank. These characteristics apply particularly to an above-ground storage tank, but may also apply to a storage tank which is below ground or which is submerged in some other medium.

During filling of the storage tank, a tanker truck or some other source of a liquid is connected with the tank inlet in some manner so that the liquid can be transferred from the source of the liquid to the storage tank via the tank inlet. During dispensing of the liquid from the storage tank, the tank outlet is opened so that the liquid is dispensed via the tank outlet.

During filling of the storage tank, gas such as air, water vapour and/or volatile hydrocarbons within the storage tank must be expelled from the storage tank in order to avoid a buildup of excessive pressure within the storage tank. During dispensing of the liquid from the storage tank, gas must be permitted to be introduced into the storage tank to avoid the creation of a vacuum within the storage tank. The gas is typically expelled from the storage tank and introduced into the storage tank either through the tank inlet or through a separate gas outlet.

If the storage tank is provided with a tank inlet and a separate gas outlet, the source of the liquid may be connected with the tank inlet in a manner so that the tank inlet is completely sealed during filling of the storage tank and functions only as a liquid inlet, since the necessary expulsion of gas from the storage tank will occur through the gas outlet. For example, the source of the liquid may include a conduit with a coupler or fitting which engages with a complementary coupler or fitting on the tank inlet to provide a sealed connection between the tank inlet and the source of the liquid. During dispensing of the liquid from this type of storage tank, the necessary introduction of gas into the storage tank can occur through the gas outlet.

If the storage tank is not provided with a separate gas outlet, the necessary expulsion of gas during filling of the storage tank must occur through the tank inlet so that the tank inlet functions as both a liquid inlet and a gas outlet. For example, the source of the liquid may include a hose which is smaller than the tank inlet and which is inserted and held in the tank inlet during filling of the storage tank, thus effectively providing a gas outlet during filling of the storage tank in that portion of the tank inlet which surrounds the hose. During dispensing of the liquid from this type of storage tank, the tank inlet is left open so that the necessary introduction of gas into the storage tank can occur through the tank inlet.

Due to the sealed connection that can be provided between the source of the liquid and the tank inlet because the tank inlet functions only as a liquid inlet, a storage tank which includes a gas outlet which is separate from the tank inlet is potentially safer and relatively more spillproof during filling than a storage tank which does not include a separate gas outlet and which therefore requires the tank inlet to function as both a liquid inlet and a gas outlet.

In addition, a storage tank which includes a tank inlet, a separate gas outlet, and a sealed connection between the source of liquid and the tank inlet may easily be configured through the use of appropriate piping and valving so that the sealed connection is at any convenient position relative to the storage tank. For example, the tank inlet may be located anywhere on the storage tank and the sealed connection may or may not be located at the location of the tank inlet, while the gas outlet may be located at an upper end of the storage tank in order to allow for gas both to exit the storage tank during filling of the storage tank and to enter the storage tank during dispensing of liquid from the storage tank.

In contrast, a storage tank which does not include a gas outlet separate from the tank inlet must typically be configured so that the tank inlet is located at or near an upper end of the storage tank in order to avoid leaking of liquid through the tank inlet either during filling of the storage tank with the liquid or during dispensing of the liquid from the storage tank.

Regardless of whether the storage tank includes a separate gas outlet or whether the tank inlet functions as both the liquid inlet and the gas outlet, the potential exists for spilling of the liquid through the gas outlet in the event that the storage tank is overfilled. It would therefore be advantageous if the separate gas outlet or the tank inlet which functions as a gas outlet, as the case may be, could communicate with a secondary containment facility so that liquid overflowing the storage tank is not permitted to spill.

There is therefore a need for a filling device for a storage tank and for a storage tank system which enable a tank inlet to function as both a liquid inlet and a gas outlet, while providing segregated paths for the liquid and the gas through the tank inlet. There is also a need for a filling device for a storage tank and for a storage tank system which enable a tank inlet to function as both a liquid inlet and a gas outlet while facilitating a sealed connection during filling of the storage tank between the source of the liquid and the tank inlet. There is also a need for a filling device for a storage tank and for a storage tank system which facilitate the filling of the storage tank from a convenient position relative to the storage tank. There is also a need for a filling device for a storage tank and for a storage tank system which provide for secondary containment of liquids which overflow from the storage tank.

### SUMMARY OF THE INVENTION

The present invention relates to a filling device for a storage tank comprising a tank inlet and to a storage tank system comprising a storage tank and a filling device.

The filling device is comprised of a manifold which connects with the tank inlet and enables the tank inlet of the storage tank to function as both a liquid inlet and a gas outlet during filling of the storage tank. More specifically, the manifold segregates the tank inlet into separate isolated paths to provide the liquid inlet and the gas outlet.

In one aspect, the invention is a filling device for a storage tank, the storage tank comprising a tank inlet and defining an interior, the filling device comprising a manifold adapted to connect with the tank inlet, the manifold comprising an outer conduit communicating with the interior of the storage tank, an inner conduit communicating with the interior of the storage tank and extending within the outer conduit, a gas outlet communicating with one of the outer conduit and the inner conduit, and a liquid inlet communicating with the other of the outer conduit and the inner conduit, wherein the storage tank may be filled with a liquid through the liquid inlet while simultaneously permitting venting of the storage tank through the gas outlet.

In a second aspect, the invention is a storage tank system which is comprised of both the storage tank and the filling device.

The storage tank is typically comprised of an upper end. The tank inlet of the storage tank may be located substantially at the upper end of the storage tank so that the tank inlet is above the normal height of the liquid in the storage tank when the storage tank is considered to be full, in which case the gas outlet communicates with the outer conduit, the outer conduit communicates with the interior of the storage tank substantially at the upper end of the storage tank, and the liquid inlet communicates with the inner conduit. This configuration will enable a gas contained within the storage tank to access the outer conduit and thus the gas outlet while enabling the storage tank simultaneously to be filled with the liquid through the liquid inlet.

Alternatively, the tank inlet may be located at some other position on the storage tank which is below the normal height of the liquid in the storage tank when the storage tank is considered to be full, in which case the gas outlet communicates with the inner conduit, the inner conduit communicates with the interior of the storage tank substantially at the upper end of the storage tank, and the liquid inlet communicates with the outer conduit. This configuration will enable a gas contained within the storage tank to access the inner conduit and thus the gas outlet while enabling the storage tank simultaneously to be filled with the liquid through the liquid inlet.

In preferred embodiments, the tank inlet is located substantially at the upper end of the storage tank so that the tank inlet is above the normal height of the liquid in the storage tank when the storage tank is considered to be full, with the result that the gas outlet communicates with the outer conduit, the outer conduit communicates with the interior of the storage tank substantially at the upper end of the storage tank, and the liquid inlet communicates with the inner conduit.

The manifold may be adapted to connect with the tank inlet in any manner. Preferably the manifold is comprised of a connection surface for connecting the manifold with the tank inlet. The connection surface may be any surface which will engage with the tank inlet to connect the manifold with the tank inlet. The connection surface may for example be comprised of a flange or other surface which may be welded to the tank inlet. Preferably, however, the connection surface is compatible with and complementary to an existing surface associated with the tank inlet. For example, the connection surface may be comprised of threads are compatible with threads associated with the tank inlet.

The manifold may be further comprised of an upper end and a lower end, wherein the lower end of the manifold is the end which is intended to be in the closest proximity to the storage vessel. The connection surface is preferably located between the upper end and the lower end of the manifold so that a portion of the manifold projects within the interior of the storage tank.

The inner conduit extends within the outer conduit such that the inner conduit is contained within the transverse cross-sectional area defined by the outer conduit. Preferably the inner conduit and the outer conduit are substantially concentric so that an annular space is provided between the inner conduit and the outer conduit. The inner conduit and the outer conduit preferably have different lengths.

In preferred embodiments the inner conduit extends to the lower end of the manifold so that the inner conduit projects within the interior of the storage tank. This configuration enables the liquid to be delivered into the storage tank below the upper end of the storage tank, thus minimizing splashing and turbulence within the storage tank during a filling operation.

In preferred embodiments the inner conduit extends to the upper end of the manifold so that the liquid inlet is located at the upper end of the manifold.

The manifold may be further comprised of a sealing device for sealing the outer conduit within the manifold. Preferably the outer conduit extends from the connection surface to the sealing device and preferably the gas outlet is located between the connection surface and the sealing device so that the gas outlet is located in a sidewall of the manifold. The outer conduit may also extend from the connection surface toward the lower end of the manifold, but preferably not to the extent that the outer conduit projects below the normal height of the liquid in the storage tank when the storage tank is considered to be full.

The filling device may be further comprised of a filling conduit which is connected with the liquid inlet, wherein the filling conduit comprises a filling inlet. The filling conduit may be comprised of any shape or length and may be constructed of any suitable material or combination of materials. The filling conduit may be connected with the liquid inlet in any manner or may be formed integrally with the manifold. Preferably the filling conduit is constructed entirely or substantially of metal and is connected with the liquid inlet by welding or with a threaded connection. The filling inlet may be provided with a removable cap to prevent debris from entering the filling conduit when the filling device is not in use.

A source of the liquid may be interfaced with the filling inlet during a filling operation in order to fill the storage tank through the filling conduit and the liquid inlet. The filling inlet may therefore be comprised of an orifice which can accommodate a hose or other device associated with the source of the liquid during a filling operation.

Preferably the filling inlet provides a mechanical connection between the filling conduit and the source of the fluid during a filling operation. As a result, the filling inlet is preferably further comprised of a filling conduit coupling mechanism which is adapted to engage with a complementary coupling mechanism associated with the source of the liquid in order to connect the filling conduit with the source of the liquid. More preferably the filling conduit coupling mechanism is adapted to engage with the complementary coupling mechanism in order to sealingly connect the filling conduit with the source of the liquid. In other words, preferably a sealed connection is provided between the filling conduit and the source of the liquid so that leakage and spilling can be minimized during a filling operation.

In preferred embodiments the filling conduit coupling mechanism is comprised of a coupling mechanism which is compatible with a hose fitting of the type which is typically found on refueling trucks. More particularly, in preferred embodiments the filling conduit coupling mechanism is comprised of a cam lock style hose fitting.

The filling conduit is preferably configured so that when the filling device is connected with the tank inlet, the filling inlet is positioned at a lower elevation than the tank inlet. Preferably the storage tank is an above-ground storage tank and preferably the filling conduit is configured so that when the filling device is connected with the tank inlet, the filling inlet may be accessed while standing on a ground surface adjacent to the storage tank. In other words, the filling conduit is preferably configured so that a filling operation can be conducted from ground level, regardless of the location of the tank inlet on the storage tank.

The filling device may be further comprised of a venting conduit which is connected with the gas outlet. The venting conduit may be comprised of any shape or length and may be constructed of any suitable material or combination of materials. The venting conduit may be connected with the gas outlet in any manner and may be formed integrally with the manifold. Preferably the venting conduit at least partly of metal and is connected with the gas outlet by welding or with a threaded connection.

Preferably the venting conduit is configured so that when the filling device is connected with the tank inlet, the venting conduit communicates with a secondary containment vessel so that liquid which overflows the storage tank through the gas outlet may be contained without spilling. As a result, the venting conduit may be constructed partly of a suitable flexible hose material so that the venting conduit can be manipulated to communicate with the secondary containment vessel. Where a secondary containment vessel is not otherwise present, the filling device is preferably further comprised of the secondary containment vessel.

The filling device may be further comprised of a liquid level gauge for providing an indication of the level of the liquid in the storage tank. Preferably the liquid level gauge provides an indication of the level of the liquid in the storage tank as the level approaches the normal height of the liquid in the storage tank when the storage tank is considered to be full. The liquid level gauge may be comprised of any suitable structure, device or apparatus. Preferably the liquid level gauge is comprised of a float which is adapted to extend within the storage tank and a reciprocable indicator arm connected with the float. Preferably the indicator arm extends through the outer conduit and projects from the manifold so that the indicator arm is visible during a filling operation.

### BRIEF DESCRIPTION OF DRAWINGS

Embodiments of the invention will now be described with reference to the accompanying drawings, in which:

FIG. 1 is a schematic drawing of a preferred embodiment of a storage tank system according to the invention, including a storage tank and a filling device.

FIG. 2 is a longitudinal section view of a preferred embodiment of a manifold according to the invention.

FIG. 3 is a longitudinal section view of an alternate preferred embodiment of a manifold according to the invention, including a liquid level gauge.

### DETAILED DESCRIPTION

The present invention relates to a filling device for a storage tank and to a storage tank system comprising a storage tank and a filling device.

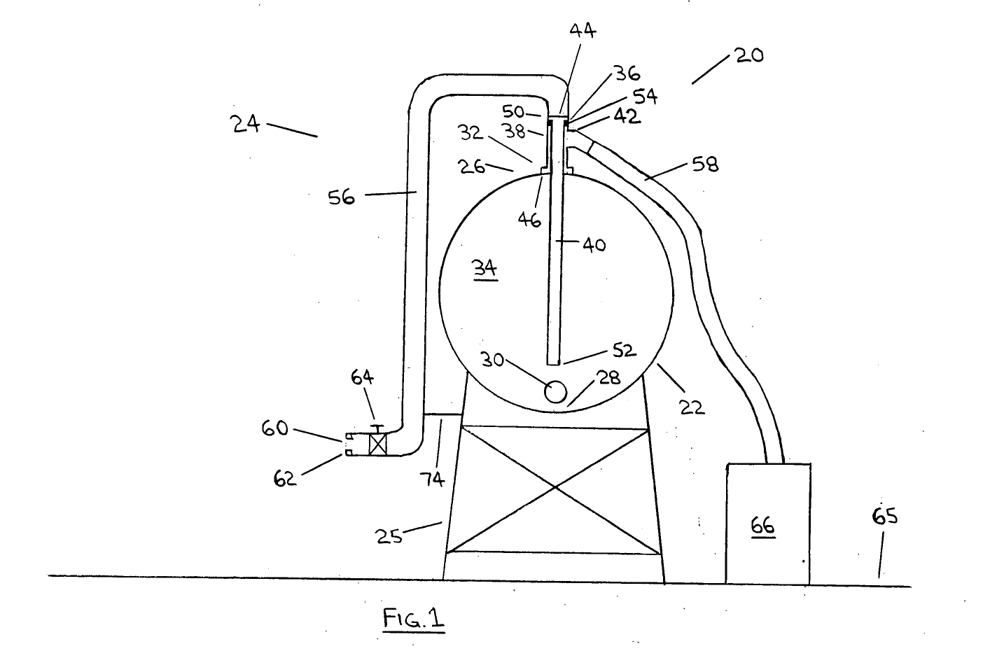

Referring to FIG. 1, the storage tank system (20) includes a storage tank (22) and a filling device (24).

The storage tank (22) is preferably an above-ground storage tank which is used for storing a liquid (not shown). The liquid is preferably a fuel such as gasoline or diesel, but the liquid may be comprised of any other liquid or combination of liquids, including water, pesticides, herbicides, cleaning agents, lubricating oils etc. As a result, the storage tank preferably includes a stand (25).

The storage tank (22) has an upper end (26) and a lower end (28). A tank outlet (30) for dispensing the liquid from the storage tank (22) is located near the lower end (28) of the storage tank (22). The tank outlet (30) may be opened and closed by turning a knob or handle (not shown) which is associated with the tank outlet (30). The tank outlet (30) may be connected with a hose or other flexible conduit (not shown) to facilitate dispensing of the liquid to a receptacle such as a gas tank on a vehicle, gas can etc. The tank outlet (30) is typically closed except during dispensing of the liquid.

The storage tank (22) further includes a tank inlet (32) which is located substantially at the upper end (26) of the storage tank (22). In the preferred embodiment depicted in FIG. 1, the storage tank (22) is not provided with a separate gas outlet. As a result, the tank inlet (30) must function as both a liquid inlet and a gas outlet. The storage tank (22) could, however, include a separate gas outlet, in which case some of the features of the filling device (24) would be of less importance.

The storage tank (22) defines an interior (34). Both the tank outlet (30) and the tank inlet (32) communicate with the interior (34) of the storage tank (22).

Conventionally, the storage tank (22) is filled by opening the tank inlet (32) and inserting a filling hose (not shown) from a refueling truck (not shown) or other source of the liquid into the tank inlet (32). The filling hose does not completely block or seal the tank inlet (32), with the result that gas such as air, water vapour and/or volatile hydrocarbons contained within the storage tank (22) may be expelled or vented from the storage tank (22) through the tank inlet (32) during a filling operation. The storage tank (22) is therefore filled as the liquid is passed through the tank inlet (32) and into the interior (34) of the storage tank (22).

There are several disadvantages associated with the conventional filling operation. First, the person filling the storage tank (22) must be positioned above ground near the tank inlet (32) in order to monitor the filling operation. Second, the filling operation must be monitored constantly to avoid spilling due to the filling hose becoming dislodged from the tank inlet (32). Third, even if due care is taken in monitoring the filling operation, the lack of a sealed connection between the filling hose and the tank inlet (32) results in a potential for overfilling of the storage tank (22) or spilling of the liquid, with potentially catastrophic results.

The filling device (24) is thus connected with the tank inlet (32) to increase the safety of the filling operation.

The filling device (24) is comprised of a manifold (36). The manifold (36) is adapted to connect with the tank inlet (32).

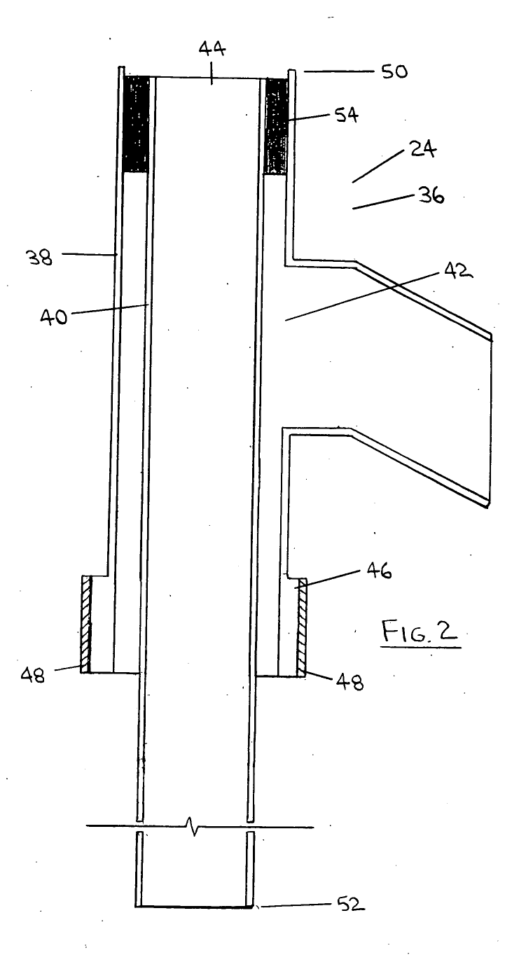

Referring to FIG. 2, the manifold (36) is comprised of an outer conduit (38) and an inner conduit (40). The inner conduit (40) extends within the outer conduit (38). In other words, the inner conduit (40) is contained within the transverse cross-sectional area defined by the outer conduit (38). This configuration serves to facilitate a maximum cross-sectional area of both the outer conduit (38) and the inner conduit (40) while permitting the manifold (36) to have a transverse dimension or diameter which is similar to the size of the tank inlet (32). This configuration also renders the preferred embodiment of the manifold (36) relatively easy to construct, since the outer conduit (38) and the inner conduit (40) may be formed from separate pipes or conduits having different transverse dimensions or diameters.

The manifold (36) may be further comprised of a housing (not shown), but in preferred embodiments the outer conduit (38) functions as a housing for the manifold (36). The outer conduit (38), the inner conduit (40), the gas outlet (42) and the liquid inlet (44) may be constructed of any suitable material, but in preferred embodiments are constructed of metal.

In the preferred embodiment, the outer conduit (38) and the inner conduit (40) are substantially concentric so that an annular space is formed between the inner surface of the outer conduit (38) and the outer surface of the inner conduit (40). Although this configuration provides a relatively efficient design which is relatively easy to construct, the inner conduit (40) may be positioned anywhere within the transverse cross-section of the outer conduit (38). The inner conduit (40) may even be positioned within the outer conduit (38) such that the outer conduit (38) and the inner conduit (40) are formed integrally and share a common length of sidewall.

The manifold (36) is further comprised of a gas outlet (42) and a liquid inlet (44).

In the preferred embodiment, the tank inlet (32) is located substantially at the upper end (26) of the storage tank (22). As a result, as depicted in FIGS. 1-3, the gas outlet (42) communicates with the outer conduit (38) and the liquid inlet (44) communicates with the inner conduit (40).

Both of the outer conduit (38) and the inner conduit (40) communicate with the interior (34) of the storage tank (22). The outer conduit (38) and the inner conduit (40) may possibly have equal lengths, but preferably the outer conduit (38) and the inner conduit (40) have different lengths.

The outer conduit (38) communicates with the interior (34) of the storage tank (22) such that gas contained within the storage tank (22) can access the outer conduit (38) and thus the gas outlet (42) in order to permit venting of the storage tank (22). Since the gas is likely to have a lower density than the liquid which is introduced into the storage tank (22), the outer conduit (38) preferably does not project within the storage tank (22) below the normal liquid level in the storage tank (22) when the storage tank is considered to be full.

It is not essential that the inner conduit (40) project within the interior (34) of the storage tank (22). Preferably, however, the inner conduit (40) projects within the interior (34) of the storage tank (22) such that the liquid will be introduced into the storage tank (22) below the interface between the liquid and the gas contained in the storage tank (22). Most preferably, the inner conduit (40) projects within the interior (34) of the storage tank (22) to a location near to the lower end (28) of the storage tank (22).

In embodiments where the tank inlet (32) is located other than substantially at the upper end (26) of the storage tank (22), the gas outlet (42) preferably communicates with the inner conduit (40) and the liquid inlet (44) preferably communicates with the outer conduit (38). In such embodiments, the inner conduit (40) preferably projects within the interior (34) of the storage tank (22) to a location substantially at the upper end (26) of the storage tank (22) so that the gas in the storage tank (22) can access the inner conduit (40) and thus the gas outlet (42). In such embodiments, the outer conduit (38) may or may not project within the interior (34) of the storage tank (22).

The manifold (36) is further comprised of a connection surface (46) for connecting the manifold (36) with the tank inlet (32). The connection surface (46) essentially defines the location of the interface between the tank inlet (30) and the manifold (36) by which the outer conduit (38) and the inner conduit (40) communicate with the interior (34) of the storage tank (22).

In preferred embodiments, the tank inlet (32) includes threads (not shown), with the result that the connection surface (46) is comprised of threads (48) which are compatible with and complementary to the threads on the tank inlet (32).

The manifold (36) has an upper end (50) and a lower end (52). In the preferred embodiments, the lower end (52) of the manifold (36) is defined by the projecting end of the inner conduit (40) and the liquid inlet (44) is located at the upper end (50) of the manifold (36), with the result that the inner conduit (40) extends from the upper end (50) of the manifold (36) to the lower end (52) of the manifold (36).

Referring to FIGS. 1-3, the connection surface (46) is located between the upper end (50) of the manifold (36) and the lower end (52) of the manifold (36).

In preferred embodiments, the manifold (36) is further comprised of a sealing device (54) for sealing the outer conduit (38). It is advantageous to seal the outer conduit (38) so that connections to the manifold (36) and the configuration of the gas outlet (42) can both be simplified. In the preferred embodiments, the sealing device (54) is comprised of a bushing which is welded in place in the annular space between the outer conduit (38) and the inner conduit (40). Other suitable structures or devices may, however, be used as the sealing device (54).

The outer conduit (38) therefore extends from the connection surface (46) to the sealing device (54) and the gas outlet (42) is located between the connection surface (46) and the sealing device (54). More particularly, the gas outlet (42) is located in a sidewall of the outer conduit (38), which also comprises a sidewall of the manifold (36).

The filling device (24) may be comprised only of the manifold (36). In preferred embodiments, the filling device (24) is further comprised of a filling conduit (56) and a venting conduit (58).

The filling conduit (56) is connected with the liquid inlet (44) to provide an extension of the inner conduit (40). Similarly, the venting conduit (58) is connected with the gas outlet (42) to provide an extension of the outer conduit (38).

The filling conduit (56) is comprised of a filling inlet (60) to facilitate filling of the storage tank (22). The filling conduit (56), including the filling inlet (60), may consist only of a length of pipe or conduit. In preferred embodiments, the filling inlet (60) is comprised of a filling conduit coupling mechanism (62) which is adapted to engage with a complementary coupling mechanism (not shown) which is associated with the source of the liquid during a filling operation. As depicted in FIG. 1, the filling conduit coupling mechanism (62) is comprised of a coupling mechanism which is compatible with a hose fitting on a fuel truck, such as for example a cam lock style hose fitting. The filling conduit coupling mechanism (62) preferably provides a sealed connection between the source of the liquid and the filling inlet (60), which in turn provides a sealed connection between the source of the liquid and the tank inlet (32) due to the configuration of the filling conduit (56).

The filling conduit (56) may be comprised of a valve (64) for opening and closing the filling conduit. The filling conduit (56) may also be comprised of a removable cap (not shown) which may be placed over the filling inlet (60) when the filling device (24) is not in use.

In preferred embodiments the filling conduit (56) is constructed of metal and is connected with the liquid inlet (44) by a welded connection between the filling conduit (56) and the upper end (50) of the manifold (36). The filling conduit (56) may be comprised of a single length of conduit, but is preferably comprised of a number of lengths of conduit welded or otherwise connected together to form the filling conduit (56).

The filling conduit (56) provides an extension of the inner conduit (40) so that the filling inlet (60) functions as the interface between the storage tank system (20) and the source of the liquid during a filling operation.

As a result, preferably the filling conduit (56) is configured so that the filling inlet (60) is located at a lower elevation than the tank inlet (32) so that a filling operation can be conducted from a lower elevation than the tank inlet (32). In preferred embodiments where the storage tank (22) is an above-ground storage tank, the filling inlet (60) is preferably located so that the filling inlet (60) may be accessed while standing on a ground surface (65) adjacent to the storage tank (22).

The venting conduit (58) is optional, since the gas can pass directly through the gas outlet (42) either from the storage tank (22) during a filling operation or into the storage tank (22) during dispensing of the liquid from the storage tank (22). As a result, the venting conduit (58) may be of any length and may be constructed from a wide range of materials or combination of materials.

In preferred embodiments the venting conduit (58) communicates with a secondary containment vessel (66). The second containment vessel (66) may be considered to be a component of the storage vessel system (20) or a component of the filling device (24). In preferred embodiments the venting conduit (58) is comprised of a length of metal conduit which is connected with the gas outlet (42) by a welded connection and is further comprised of a length of a flexible hose which can be manipulated to communicate with the secondary containment vessel (66).

The venting conduit (58) and the secondary containment vessel (66) therefore provide a safety feature by which liquid which overflows the storage tank (22) through the gas outlet during a filling operation may be contained without spilling.

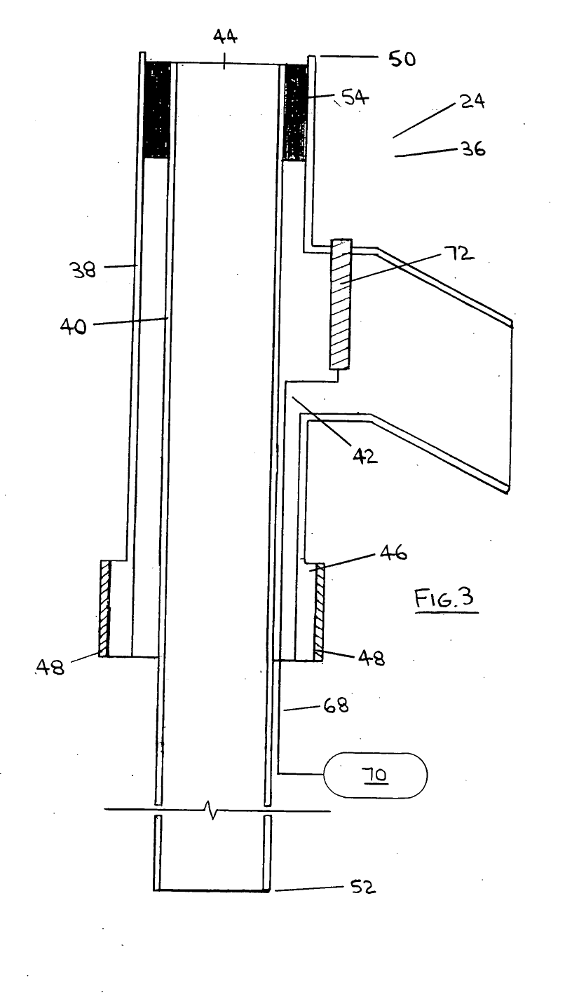

The filling device (24) may be further comprised of a liquid level gauge (68) for providing an indication of the level of the liquid within the storage tank (22), particularly as the level of the liquid approaches the level where the storage tank (22) is considered to be full. Referring to FIG. 3, an exemplary liquid level gauge (68) is depicted, which liquid level gauge (68) is comprised of a float (70) which is adapted to extend within the storage tank (22) and a reciprocable indicator arm (72) connected with the float (70).

As depicted in FIG. 3, the indicator arm (72) extends through the outer conduit (38) and projects from the manifold (36) in the vicinity of the gas outlet (42). As the liquid level in the storage tank (22) rises during a filling operation, the float (70) and the indicator arm (72) move upward to provide an indication that the level of the liquid is approaching the upper end (26) of the storage tank (22).

The filling device (24) as described above may be installed on a storage tank (22) in order to provide a storage tank system (20). Alternatively the storage tank (22) and the filling device (24) may be constructed together to provide the storage tank system (20).

In use, the storage tank system (24) is constructed either by installing the filling device (24) on an existing storage tank (22) or by constructing the storage tank (22) and the filling device (24) together. If desired, the filling conduit (56) may be connected with the stand (25) of the storage tank (22) with a brace (74) so that the filling conduit (56) is supported both by the manifold (36) and the storage tank (22).

In preparation for a filling operation, the tank outlet (30) is closed and a filling hose is connected with the filling inlet (60) on the filling conduit (56) using the filling conduit coupling mechanism (62). This connection can be performed from ground level due to the location of the filling inlet (60).

If a valve (64) is provided in the filling conduit (56), the valve (64) is opened. Liquid may then be pumped from a source of the liquid (such as a fuel truck) into the storage tank (22).

The liquid will pass through the filling hose, through the filling inlet (60), through the filling conduit (56), through the liquid inlet (44), through the inner conduit (40) and into the interior (34) of the storage tank (22). The liquid will not pass through the outer conduit (38) due to the presence of the sealing device (54). As the liquid fills the storage tank (22), the gas contained within the storage tank (22) passes through the outer conduit (38), through the gas outlet (42), through the venting conduit (58) and into the atmosphere.

The level of the liquid in the storage tank (22) will be indicated by the liquid level gauge (68), If, however, the storage tank (22) is overfilled, excess liquid will pass through the outer conduit (38), through the gas outlet (42), through the venting conduit (58) and into the secondary containment vessel (66).

When the filling operation is complete, liquid contained in the filling conduit (58) is either forced under pressure into the storage vessel (22) or is permitted to drain out of the filling inlet (60) and back to the source of the liquid. The valve (64) may then be closed and the filling hose can be disconnected from the filling inlet (60).

During dispensing of the liquid from the storage tank (22), the tank outlet (30) is connected with a container for the liquid either directly or through a hose or some other conduit. The tank outlet (30) is then opened, causing the liquid within the storage tank (22) to drain by gravity from the storage tank (22). As the liquid is dispensed, air passes through the venting conduit (58), through the gas outlet (42), through the outer conduit (38) and into the storage tank (22) due to the reduced pressure within the storage tank (22). When the dispensing of the liquid has been completed, the tank outlet (30) is closed.

The filling device (24) and the storage tank system (20) of the preferred embodiments provide a storage tank (22) which does not include a gas outlet which is separate from the tank inlet (32) with a venting mechanism which permits gas both to be expelled from and introduced into the storage tank (22). In addition, the filling device (24) and the storage tank system (20) of the preferred embodiments enable the storage tank (22) to be filled more safely by providing a sealed connection between the source of the liquid and the liquid inlet and by facilitating filling of the storage tank (22) from ground level. Finally, the filling device (24) and the storage tank system (20) of the preferred embodiments provide secondary containment of overflowing liquids during a filling operation and also provide a visual indication of the level of the liquid in the storage tank (22) during a filling operation.

The embodiments of the invention in which an exclusive property or privilege is claimed are defined as follows:

1. A filling device for a storage tank, the storage tank comprising a tank inlet and defining an interior, the filling device comprising a manifold adapted to connect with the tank inlet, the manifold comprising an outer conduit communicating with the interior of the storage tank, an inner conduit communicating with the interior of the storage tank and extending within the outer conduit, a gas outlet communicating with one of the outer conduit and the inner conduit, and a liquid inlet communicating with the other of the outer conduit and the inner conduit, wherein the storage tank may be filled with a liquid through the liquid inlet while simultaneously permitting venting of the storage tank through the gas outlet.

2. The filling device as claimed in claim 1 wherein the storage tank is comprised of an upper end, wherein the tank inlet is located substantially at the upper end of the storage tank, wherein the gas outlet communicates with the outer conduit, wherein the outer conduit communicates with the interior of the storage tank substantially at the upper end of the storage tank, and wherein the liquid inlet communicates with the inner conduit.

3. The filling device as claimed in claim 2 wherein the manifold is comprised of a connection surface for connecting the manifold with the tank inlet, wherein the manifold is further comprised of an upper end, wherein the inner conduit extends from the connection surface to the upper end, and wherein the liquid inlet is located at the upper end.

4. The filling device as claimed in claim 3 wherein the manifold is further comprised of a sealing device for sealing the outer conduit, wherein the outer conduit extends from the connection surface to the sealing device, and wherein the gas outlet is located between the connection surface and the sealing device.

5. The filling device as claimed in claim 4 wherein the manifold is further comprised of a lower end, wherein the connection surface is located between the upper end and the lower end, and wherein the inner conduit extends from the upper end to the lower end so that the inner conduit projects within the interior of the storage tank.

6. The filling device as claimed in claim 5, further comprising a filling conduit connected with the liquid inlet, wherein the filling conduit comprises a filling inlet.

7. The filling device as claimed in claim 6 wherein the filling conduit is configured so that when the filling device is connected with the tank inlet, the filling inlet is positioned at a lower elevation than the tank inlet.

8. The filling device as claimed in claim 6 wherein the storage tank is an above-ground storage tank and wherein the filling conduit is configured so that when the filling device is connected with the tank inlet, the filling inlet is positioned at a lower elevation than the tank inlet.

9. The filling device as claimed in claim 6 wherein the storage tank is an above-ground storage tank and wherein the filling conduit is configured so that when the filling device is connected with the tank inlet, the filling inlet may be accessed while standing on a ground surface adjacent to the storage tank.

10. The filling device as claimed in claim 6, further comprising a venting conduit connected with the gas outlet, wherein the venting conduit is configured so that when the filling device is connected with the tank inlet, the venting conduit communicates with a secondary containment vessel.

11. The filling device as claimed in claim 10, further comprising the secondary containment vessel.

12. The filling device as claimed in claim 10 wherein the storage tank is an above-ground storage tank and wherein the filling conduit is configured so that when the filling device is connected with the tank inlet, the filling inlet may be accessed while standing on a ground surface adjacent to the storage tank.

13. The filling device as claimed in claim 10 wherein the connection surface is comprised of a threaded connection which is adapted to connect with a threaded connection associated with the tank inlet.

14. The filling device as claimed in claim 13, further comprising a welded connection for connecting the filling conduit and the liquid inlet and further comprising a welded connection for connecting the venting conduit and the gas outlet.

15. The filling device as claimed in claim 10, further comprising a liquid level gauge, wherein the liquid level gauge is comprised of a float which is adapted to extend within the storage tank, wherein the liquid level gauge is further comprised of a reciprocable indicator arm connected with the float, and wherein the indicator arm extends through the outer conduit and projects from the manifold.

16. The filling device as claimed in claim 10, wherein the filling inlet is comprised of a filling conduit coupling mechanism and wherein the filling conduit coupling mechanism is adapted to engage with a complementary coupling mechanism associated with a source of the liquid in order to connect the filling conduit with the source of the liquid and facilitate the filling of the storage tank.

17. The filling device as claimed in claim 16 wherein the filling conduit coupling mechanism is adapted to engage with the complementary coupling mechanism in order to sealingly connect the filling conduit with the source of the liquid.

18. A storage tank system comprising:
(a) a storage tank, the storage tank comprising a tank inlet and defining an interior; and
(b) a filling device, the filling device comprising a manifold connected with the tank inlet, the manifold comprising an outer conduit communicating with the interior of the storage tank, an inner conduit communicating with interior of the storage tank and extending within the outer conduit, a gas outlet communicating with one of the outer conduit and the inner conduit, and a liquid inlet communicating with the other of the outer conduit and the inner conduit, wherein the storage tank may be filled with a liquid through the liquid inlet while simultaneously permitting venting of the storage tank through the gas outlet.

19. The storage tank system as claimed in claim 18 wherein the storage tank is comprised of an upper end, wherein the tank inlet is located substantially at the upper end of the storage tank, wherein the gas outlet communicates with the outer conduit, wherein the outer conduit communicates with the interior of the storage tank substantially at the upper end of the storage tank, and wherein the liquid inlet communicates with the inner conduit.

20. The storage tank system as claimed in claim 19 wherein the manifold is comprised of a connection surface for connecting the manifold with the tank inlet, wherein the manifold is further comprised of an upper end, wherein the inner conduit extends from the connection surface to the upper end, and wherein the liquid inlet is located at the upper end.

21. The storage tank system as claimed in claim 20 wherein the manifold is further comprised of a sealing device for sealing the outer conduit, wherein the outer conduit extends from the connection surface to the sealing device, and wherein the gas outlet is located between the connection surface and the sealing device.

22. The storage tank system as claimed in claim 21 wherein the manifold is further comprised of a lower end, wherein the connection surface is located between the upper end and the lower end, and wherein the inner conduit extends from the upper end to the lower end so that the inner conduit projects within the interior of the storage tank.

23. The storage tank system as claimed in claim 22 wherein the filling device is further comprised of a filling conduit connected with the liquid inlet and wherein the filling conduit comprises a filling inlet.

24. The storage tank system as claimed in claim 23 wherein the filling inlet is positioned at a lower elevation than the tank inlet.

25. The storage tank system as claimed in claim 23 wherein the storage tank is an above-ground storage tank and wherein the filling inlet is positioned at a lower elevation than the tank inlet.

26. The storage tank system as claimed in claim 23 wherein the storage tank is an above-ground storage tank and wherein the filling inlet may be accessed while standing on a ground surface adjacent to the storage tank.

27. The storage tank system as claimed in claim 23 wherein the filling device is further comprised of a secondary containment vessel, wherein the filling device is further comprised of a venting conduit connected with the gas outlet, and wherein the venting conduit communicates with the secondary containment vessel.

28. The storage tank system as claimed in claim 27 wherein the storage tank is an above-ground storage tank and wherein the filling inlet may be accessed while standing on a ground surface adjacent to the storage tank.

29. The storage tank system as claimed in claim 27 wherein the connection surface is comprised of a threaded connection which connects with a threaded connection associated with the tank inlet.

30. The storage tank system as claimed in claim 29, wherein the filling device is further comprised of a welded connection for connecting the filling conduit and the liquid inlet and wherein the filling device is further comprised of a welded connection for connecting the venting conduit and the gas outlet.

31. The storage tank system as claimed in claim 27 wherein the filling device is further comprised of a liquid level gauge, wherein the liquid level gauge is comprised of a float which extends within the storage tank, wherein the liquid level gauge is further comprised of a reciprocable indicator arm connected with the float, and wherein the indicator arm extends through the outer conduit and projects from the manifold.

32. The storage tank system as claimed in claim 27 wherein the filling inlet is further comprised of a filling conduit coupling mechanism, and wherein the filling conduit coupling mechanism is adapted to engage with a complementary coupling mechanism associated with a source of the liquid in order to connect the filling conduit with the source of the liquid and facilitate the filling of the storage tank.

33. The storage tank system as claimed in claim 32 wherein the filling conduit coupling mechanism is adapted to engage with the complementary coupling mechanism in order to sealingly connect the filling conduit with the source of the liquid.
